(19) United States
(12) Patent Application Publication
(10) Pub. No.: US 2026/0243300 A1
(43) Pub. Date: Aug. 20, 2026

(54) WHEEL BEARING FOR PART-TIME FOUR-WHEEL DRIVE VEHICLE

(71) Applicant: ILJIN GLOBAL CO.,LTD, Seoul (KR)

(72) Inventors: Jun Ho LEE, Seoul (KR); Hee Jae YOON, Seoul (KR); Hyo Chang SEONG, Seoul (KR)

(73) Assignee: ILJIN GLOBAL CO.,LTD, Seoul (KR)

(21) Appl. No.: 19/545,203

(22) Filed: Feb. 20, 2026

(30) Foreign Application Priority Data
Feb. 20, 2025 (KR) 10-2025-0022577

(51) Int. Cl. F16C 19/38; B60B 27/00; B60B 27/02; B60K 17/35; F16C 19/18

(52) U.S. Cl. CPC F16C 19/38; B60B 27/001; B60B 27/0026; B60B 27/0078; B60B 27/02; B60B 2310/54; B60B 2900/212; B60K 17/3515; F16C 19/18; F16C 2326/02

(57) ABSTRACT

A wheel bearing for a part-time four-wheel drive vehicle capable of switching between a two-wheel drive mode and a four-wheel drive mode may be provided. The wheel bearing includes a wheel hub to which a vehicle wheel is mounted and which rotates together with the vehicle wheel; at least one inner ring mounted to the wheel hub; an outer ring fixedly coupled to a vehicle-body-side member; a plurality of rolling elements configured to rotatably support the wheel hub and the inner ring relative to the outer ring; and a coupler mounted to the wheel hub. The coupler includes outer circumferential surface splines extending in an axial direction on an outer circumferential surface thereof, and the outer circumferential surface splines of the coupler may be configured such that a hardening heat treatment is performed at least on a portion that is engaged with a clutch member.

### CROSS-REFERENCE TO RELATED APPLICATION

This application claims priority to Korean Patent Application No. 10-2025-0022577 filed on February 20, 2026, the entire contents of which are herein incorporated by reference.

### TECHNICAL FIELD

The present disclosure relates to a vehicular wheel bearing for rotatably mounting and supporting a vehicle wheel to a vehicle body, and more particularly, to a wheel bearing for a part-time four-wheel drive vehicle capable of switching between a two-wheel drive mode and a four-wheel drive mode.

### DESCRIPTION OF THE RELATED ART

Referring to FIG. 1, a wheel bearing 10 for a part-time four-wheel drive vehicle, which is configured to selectively connect and disconnect a drive shaft and the wheel bearing so as to be switchable between a two-wheel drive mode and a four-wheel drive mode, is illustratively shown.

As shown in FIG. 1, the wheel bearing 10 for a part-time four-wheel drive vehicle may be configured, similarly to conventional wheel bearings, such that a rotating element (for example, a wheel hub 20 and an inner ring 30) to which a vehicle wheel is mounted is connected to a non-rotating element (for example, an outer ring 40) fixed to a vehicle body through a plurality of rolling elements 50, thereby rotatably mounting and supporting the vehicle wheel with respect to the vehicle body.

Further, a coupler 60 having splines may be coupled to a vehicle-body-side end portion of the wheel hub 20, such that a drive shaft is selectively connected to or disconnected from the wheel bearing through the coupler 60.

For example, when a clutch member 70 that rotates in synchronization with a drive shaft (for example, a constant velocity joint 80) is moved axially outward so that splines formed on an inner circumferential surface of the clutch member 70 are engaged with splines formed on an outer circumferential surface of the coupler 60, the wheel bearing is connected to the drive shaft and receives driving power therefrom. Conversely, when the clutch member 70 is moved axially inward so that the splines formed on the inner circumferential surface of the clutch member 70 are disengaged from the splines formed on the outer circumferential surface of the coupler 60, transmission of driving power between the wheel bearing and the drive shaft is released.

However, in the vehicular wheel bearing 10 for a part-time four-wheel drive vehicle having such a structure, there may arise a problem in that damage occurs to tooth portions of the splines provided on the outer circumferential surface of the coupler 60 during a process in which power is transmitted by spline-engagement with the clutch member 70, or during a process in which the clutch member 70 is repeatedly engaged with and/or disengaged from the coupler 60, thereby requiring countermeasures to address this issue.

### DISCLOSURE OF THE INVENTION

### TECHNICAL GOALS

The present disclosure has been made to address the above-described problems, and the present disclosure is for the purpose of providing a wheel bearing for a part-time four-wheel drive vehicle capable of switching between a two-wheel drive mode and a four-wheel drive mode, in which a hardening heat treatment is performed on splines formed on an outer circumferential surface of a coupler that is engaged with a clutch member, thereby securing strength required for stable transmission of driving power while preventing occurrence of damage, such as cracks, in tooth portions of the splines.

### TECHNICAL SOLUTIONS

Representative configurations of the present disclosure to achieve the above-described purpose are as follows.

According to an embodiment of the present disclosure, a wheel bearing for a part-time four-wheel drive vehicle capable of switching between a two-wheel drive mode and a four-wheel drive mode may be provided. The wheel bearing according to an embodiment of the present disclosure may comprise: a wheel hub to which a vehicle wheel is mounted and which rotates together with the vehicle wheel; at least one inner ring mounted to the wheel hub; an outer ring fixedly coupled to a vehicle-body-side member; a plurality of rolling elements configured to rotatably support the wheel hub and the inner ring relative to the outer ring; and a coupler mounted to the wheel hub. According to an embodiment of the present disclosure, the coupler may comprise outer circumferential surface splines extending in an axial direction on an outer circumferential surface thereof, and the outer circumferential surface splines of the coupler may be configured such that a hardening heat treatment is performed at least on a portion that is engaged with a clutch member.

According to an embodiment of the present disclosure, the outer circumferential surface splines of the coupler subjected to the hardening heat treatment may be configured such that a surface hardness measured at a pitch circle diameter portion is in a range of 600 HV to 660 HV.

According to an embodiment of the present disclosure, the outer circumferential surface splines of the coupler subjected to the hardening heat treatment may be configured such that a surface hardness measured at a pitch circle diameter portion is in a range of 620 HV to 640 HV.

According to an embodiment of the present disclosure, the coupler may comprise a recess recessed radially inward on an outer circumferential surface thereof.

According to an embodiment of the present disclosure, a stopper member configured to limit axial movement of the clutch member may be inserted into and coupled to the recess of the coupler.

According to an embodiment of the present disclosure, the stopper member may be formed as a snap ring having elasticity.

According to an embodiment of the present disclosure, the stopper member may be formed as a C-shaped snap ring having a portion cut away in a circumferential direction.

According to an embodiment of the present disclosure, the stopper member may be configured to be positioned axially inward relative to an axial center of the coupler.

According to an embodiment of the present disclosure, outer circumferential surface splines of the coupler that are positioned axially inward relative to the stopper member may be formed to have an axial length that is in a range of 30% to 50% of an axial length of the clutch member.

According to an embodiment of the present disclosure, outer circumferential surface splines of the coupler that are positioned axially inward relative to the stopper member may be formed to have an axial length that is in a range of 30% to 50% of an axial length of the coupler.

According to an embodiment of the present disclosure, the inner ring and the coupler may be configured to be fixed on the wheel hub by a forming portion formed by plastically deforming an inner axial end portion of the wheel hub radially outward.

According to an embodiment of the present disclosure, the coupler may comprise inner circumferential surface splines extending in an axial direction on an inner circumferential surface thereof, such that the inner circumferential surface splines are spline- coupled to the wheel hub.

According to an embodiment of the present disclosure, the coupler may comprise a protrusion protruding radially inward from an inner circumferential surface portion that is positioned axially inward relative to the inner circumferential surface splines.

According to an embodiment of the present disclosure, the wheel hub may comprise an inner-ring mounting portion and a coupler mounting portion on an outer circumferential surface thereof, wherein the inner-ring mounting portion may comprise a cylindrical press-fit portion such that the inner ring is press-fitted to the cylindrical press-fit portion, and the coupler mounting portion may comprise a spline coupling portion extending in an axial direction such that the inner circumferential surface splines of the coupler are spline-coupled to the spline coupling portion of the coupler mounting portion.

According to an embodiment of the present disclosure, an outer diameter of the spline coupling portion provided on the coupler mounting portion may be formed to be smaller than an outer diameter of the cylindrical press-fit portion of the inner-ring mounting portion.

In addition, the vehicular wheel bearing according to the present disclosure may further comprise other additional components to the extent that it does not impair the technical idea of the present disclosure.

### EFFECTS

The vehicular wheel bearing according to an embodiment of the present disclosure is configured such that a hardening heat treatment is performed on outer circumferential surface splines of a coupler that is engaged with a clutch member to transmit driving power, thereby securing strength required for stable transmission of driving power at the outer circumferential surface splines of the coupler.

In addition, the vehicular wheel bearing according to an embodiment of the present disclosure is configured to perform the hardening heat treatment while controlling the outer circumferential surface splines of the coupler to have a surface hardness within a predetermined range, thereby reducing a risk of occurrence of damage, such as cracks, in tooth portions of the outer circumferential surface splines of the coupler even when the hardening heat treatment is performed.

### BRIEF DESCRIPTION OF THE DRAWINGS

FIG. 1 illustratively shows an example of a wheel bearing for a part-time four-wheel drive vehicle.

FIG. 2 illustratively shows a vehicular wheel bearing according to an embodiment of the present disclosure.

FIG. 3 illustratively shows a cross-sectional structure of the vehicular wheel bearing according to an embodiment of the present disclosure.

FIG. 4 illustratively shows a structure of a coupler applicable to the vehicular wheel bearing according to an embodiment of the present disclosure.

FIG. 5 illustratively shows a state in which cracks have occurred in tooth portions of splines due to a hardening heat treatment performed on outer circumferential surface splines of the coupler with a high surface hardness (for example, a surface hardness exceeding 660 HV).

### DETAILED DESCRIPTION

Example embodiments of the present disclosure described herein are exemplified for the purpose of describing the technical spirit of the present disclosure. The scope of the claims according to the present disclosure is not limited to the example embodiments described below or to detailed descriptions of these example embodiments.

Unless otherwise defined, all technical and scientific terms used herein have the same meaning commonly understood by those skilled in the art to which the present disclosure pertains. All terms used herein are selected for the purpose of more clearly describing the present disclosure and not limiting the scope of the present disclosure defined by appended claims.

Unless the phrase or sentence clearly indicates otherwise, terms "comprising," "including," "having," and the like used herein should be construed as open-ended terms encompassing the possibility of including other example embodiments.

The term "axial direction" used herein may be defined as a direction extending along a rotational central axis of a wheel bearing, wherein “axially inner” refers to a direction toward a vehicle body, and “axially outer” refers to a direction toward a wheel. The term "radial direction" used herein may be defined as a direction perpendicular to the axial direction and away from the rotational central axis or approaching the rotational central axis. The term "circumferential direction" used herein may be defined as a direction rotating about the axial direction described above.

Unless the phrase or sentence clearly indicates otherwise, the expression "a constituent element extends in the axial direction or the radial direction" used herein should be understood as encompassing a case where the constituent element extends parallel to the axial direction or the radial direction as well as a case where the constituent element extends obliquely with respect to the axial direction or the radial direction.

The singular form described herein may include the plural form unless the context clearly dictates otherwise, and this is equally applied to the singular form set forth in the claims.

Throughout the present specification, when a constituent element is referred to as being "positioned" at or "formed" on one side of another constituent element, the constituent element may be in direct contact with or directly formed on the one side of another constituent element, or may be positioned at or formed on another constituent element by intervening yet another constituent element therebetween.

Hereinafter, preferred embodiments of the present disclosure will be described in detail with reference to the accompanying drawings to such an extent that a person having ordinary skill in the art to which the present disclosure pertains can readily practice the present disclosure. In the accompanying drawings, the same reference numerals are assigned to the same or corresponding components. Furthermore, in the following descriptions of the example embodiments, duplicate description(s) of the same or corresponding constituent elements may be omitted. However, even if description(s) of a specific component is omitted in the following description, this is not intended to mean that such component is excluded from the corresponding embodiment.

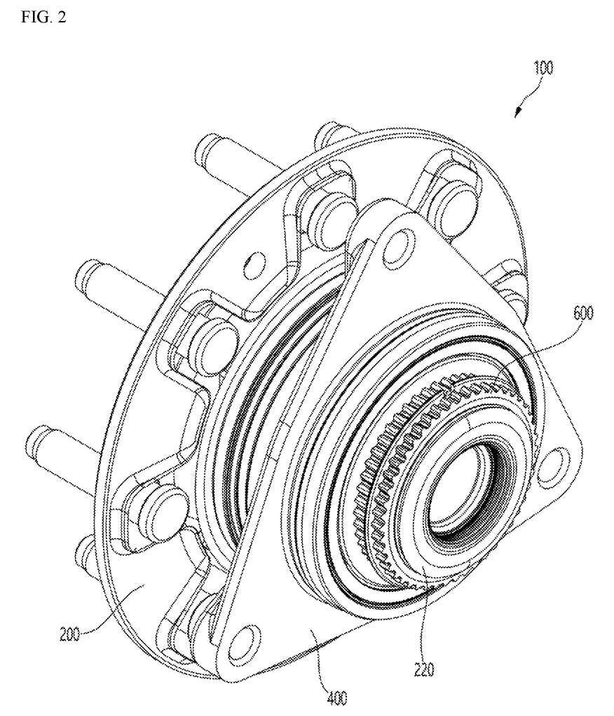

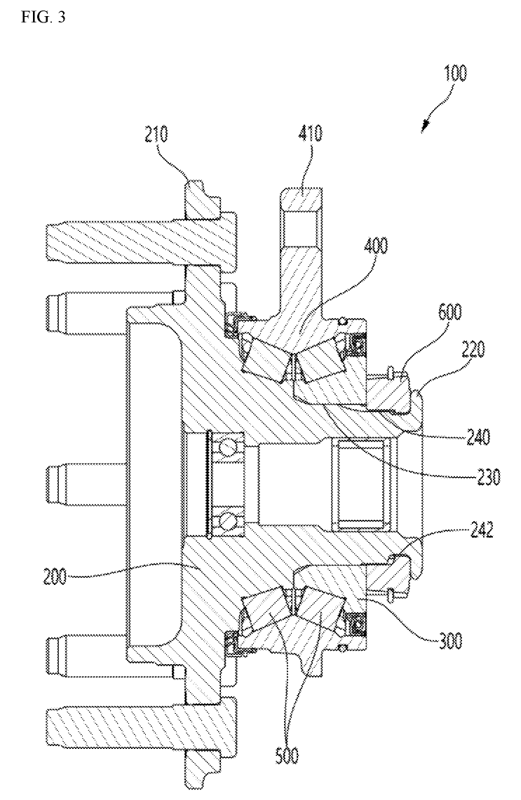

Referring to FIGS. 2 and 3, a vehicular wheel bearing 100 according to an embodiment of the present disclosure is illustratively shown. As shown in the drawings, the vehicular wheel bearing 100 according to an embodiment of the present disclosure may be configured as a wheel bearing for a part-time four-wheel drive vehicle capable of switching between a two-wheel drive mode and a four-wheel drive mode.

According to an embodiment of the present disclosure, the vehicular wheel bearing 100 may comprise: a wheel hub 200 to which a vehicle wheel is mounted and which rotates together with the vehicle wheel; at least one inner ring 300 mounted on the wheel hub 200; an outer ring 400 fixedly coupled to a vehicle-body-side member; a plurality of rolling elements 500 configured to rotatably support the wheel hub 200 and the inner ring 300 relative to the outer ring 400; and a coupler 600 mounted to the wheel hub 200 and configured to selectively engage with a clutch member (not shown).

According to an embodiment of the present disclosure, the wheel hub 200 may be formed in a substantially cylindrical structure extending along an axial direction, and a wheel-mounting flange 210 (hub flange) may be provided on an outer circumferential surface on one side of the wheel hub 200. The wheel-mounting flange 210 may be formed to extend radially outward from the outer circumferential surface of the wheel hub 200 and may be used to mount a vehicle wheel to the wheel hub 200 using hub bolts or the like. Meanwhile, the inner ring 300 and the coupler 600 may be coupled to a vehicle-body-side end portion of the wheel hub 200, and the inner ring 300 and the coupler 600 may be fixed on the wheel hub 200 by a forming portion 220 formed by plastically deforming the vehicle-body-side end portion of the wheel hub 200 radially outward.

According to an embodiment of the present disclosure, at least one inner ring 300 may be mounted on the outer circumferential surface of the wheel hub 200, and an outer circumferential surface of the inner ring 300 may be formed with a raceway surface (an inner raceway surface) for rolling elements so as to support the rolling elements 500 from a radially inner side. For example, the inner ring 300 may be press-fitted and mounted to an inner-ring mounting portion 230 provided on the outer circumferential surface of the wheel hub 200.

According to an embodiment of the present disclosure, the outer ring 400 may comprise, on an outer circumferential surface thereof, a vehicle-body-side mounting flange 410 used to mount the wheel bearing 100 to a vehicle-body-side member (for example, a chassis member such as a knuckle), and may comprise, on an inner circumferential surface thereof, raceway surfaces that contact the rolling elements 500. The raceway surfaces (outer raceway surfaces) formed on the inner circumferential surface of the outer ring 400 may cooperate with raceway surfaces (inner raceway surfaces) formed on the wheel hub 200 and/or the inner ring 300 to receive and support the rolling elements 500, which are rolling members, between the raceway surfaces.

According to an embodiment of the present disclosure, the rolling elements 500 may be interposed between a rotating element (for example, the wheel hub 200 and/or the inner ring 300) of the wheel bearing 100 and a non-rotating element (for example, the outer ring 400) of the wheel bearing 100, and may perform a function of rotatably supporting the rotating element of the wheel bearing 100 relative to the non-rotating element of the wheel bearing 100.

However, the above-described configurations of the vehicular wheel bearing 100 according to an embodiment of the present disclosure are not necessarily limited to the structures shown in the drawings, and may be variously modified into different structures applicable to vehicular wheel bearings.

For example, in the embodiment shown in the drawings, the vehicular wheel bearing 100 is configured such that one raceway surface for supporting rolling elements is directly formed on a portion of an outer circumferential surface of the wheel hub 200; however, the vehicular wheel bearing 100 according to an embodiment of the present disclosure may be implemented in other modified structures, such as a structure in which two inner rings 300 are mounted on the wheel hub 200 and rolling elements 500 are supported by the two inner rings 300.

In addition, in the embodiment shown in the drawings, rolling elements 500 configured to rotatably support the rotating element (for example, the wheel hub 200 and/or the inner ring 300) relative to the non-rotating element (for example, the outer ring 400) are formed in a tapered roller shape; however, the rolling elements 500 may alternatively be formed in other shapes of rolling elements, such as spherical balls.

According to an embodiment of the present disclosure, a coupler 600 may be provided at an axially inner end portion of a wheel hub 200, and the coupler 600 may be used to perform switching between a two-wheel drive mode in which transmission of driving power between the wheel bearing and a drive shaft is blocked and a four-wheel drive mode in which transmission of driving power between the wheel bearing and the drive shaft is enabled.

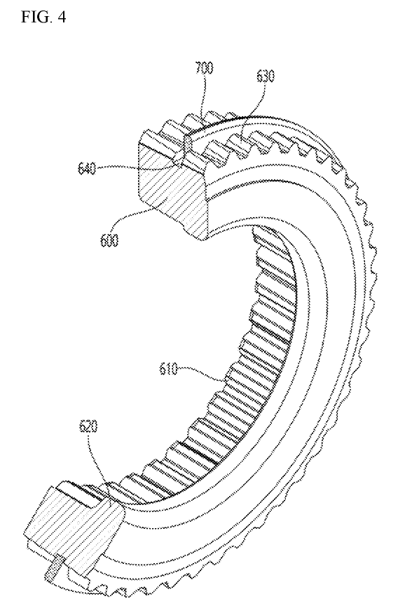

According to an embodiment of the present disclosure, the coupler 600 may be formed in a substantially ring-shaped structure having a central through-hole, and may be configured to be mounted on the wheel hub 200 at a position axially inward relative to an inner ring 300, as shown in FIG. 4.

According to an embodiment of the present disclosure, the wheel hub 200 may comprise an inner-ring mounting portion 230 and a coupler mounting portion 240 on the outer circumferential surface thereof, such that the inner ring 300 is mounted on the inner-ring mounting portion 230 provided on the wheel hub 200, and the coupler 600 is mounted on the coupler mounting portion 240 provided on the wheel hub 200.

According to an embodiment of the present disclosure, the inner-ring mounting portion 230 of the wheel hub 200 may comprise a cylindrical press-fit portion, such that the inner ring 300 is press-fitted to and mounted on the cylindrical press-fit portion.

According to an embodiment of the present disclosure, the coupler mounting portion 240 of the wheel hub 200 may comprise a spline coupling portion extending in an axial direction, such that the coupler 600 is spline-coupled to the spline coupling portion.

According to an embodiment of the present disclosure, the coupler mounting portion 240 may be positioned axially inward relative to the inner-ring mounting portion 230, and an outer diameter of the spline coupling portion provided on the coupler mounting portion 240 may be formed to be smaller than an outer diameter of the cylindrical press-fit portion of the inner-ring mounting portion 230.

According to an embodiment of the present disclosure, the coupler 600 may comprise inner circumferential surface splines 610 extending in an axial direction on an inner circumferential surface thereof, and the inner circumferential surface splines 610 of the coupler 600 may be spline-coupled to the spline coupling portion provided on the coupler mounting portion 240 of the wheel hub 200.

According to an embodiment of the present disclosure, the coupler 600 may comprise a protrusion 620 protruding radially inward from an inner circumferential surface that is positioned axially inward relative to the inner circumferential surface splines 610.

According to an embodiment of the present disclosure, the protrusion 620 may contact the wheel hub 200 when an axially inner end of the wheel hub 200 is plastically deformed to form a forming portion 220, thereby enabling stable plastic deformation of the forming portion 220.

According to an embodiment of the present disclosure, the coupler 600 may comprise outer circumferential surface splines 630 extending in an axial direction on an outer circumferential surface thereof, and switching between a two-wheel drive mode and a four-wheel drive mode may be performed as the clutch member (not shown) is engaged with and disengaged from the outer circumferential surface splines 630.

According to an embodiment of the present disclosure, switching between the two-wheel drive mode and the four-wheel drive mode through the outer circumferential surface splines 630 of the coupler 600 may be implemented substantially identically to that of conventional vehicular wheel bearings for a part-time four-wheel drive vehicle.

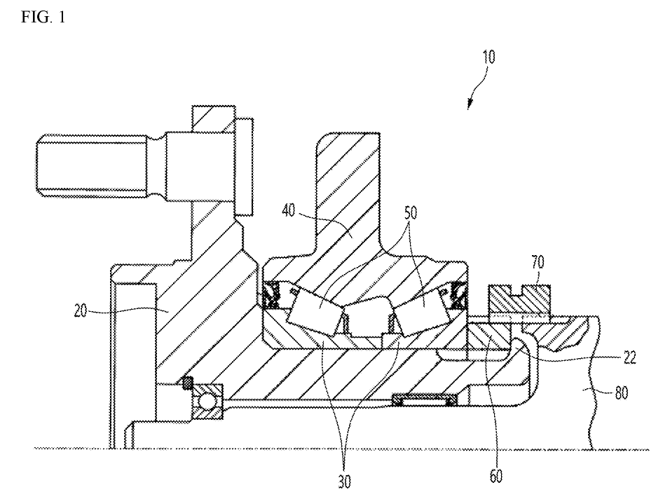

For example, similarly to the conventional vehicular wheel bearing for a part-time four-wheel drive vehicle shown in FIG. 1, the outer circumferential surface splines 630 of the coupler 600 may be selectively engaged with and disengaged from engagement splines of the clutch member that rotates in synchronization with a drive shaft (for example, a constant-velocity joint), thereby functioning to switch between a four-wheel drive state in which driving power is transmitted from the drive shaft and a two-wheel drive state in which the wheel bearing is separated from the drive shaft.

According to an embodiment of the present disclosure, the outer circumferential surface splines 630 of the coupler 600 may be configured such that a hardening heat treatment is performed at least on a portion that is engaged with the clutch member, so as to secure strength required for transmission of driving power at tooth portions of the outer circumferential surface splines 630.

According to an embodiment of the present disclosure, the hardening heat treatment performed on the outer circumferential surface splines 630 of the coupler 600 may be carried out such that a surface hardness measured at a pitch circle diameter portion of the outer circumferential surface splines 630 is in a range of 600 HV to 660 HV. [In the present specification, measuring the hardness of the outer circumferential surface splines 630 of the coupler 600 at the pitch circle diameter (PCD) portion means that the hardness measurement is performed within an error range of ±1.0 mm in a radial direction from a pitch circle diameter design value.]

According to an embodiment of the present disclosure, it may be more preferable that the hardening heat treatment performed on the outer circumferential surface splines 630 of the coupler 600 is carried out such that a surface hardness measured at the pitch circle diameter portion is in a range of 620 HV to 640 HV.

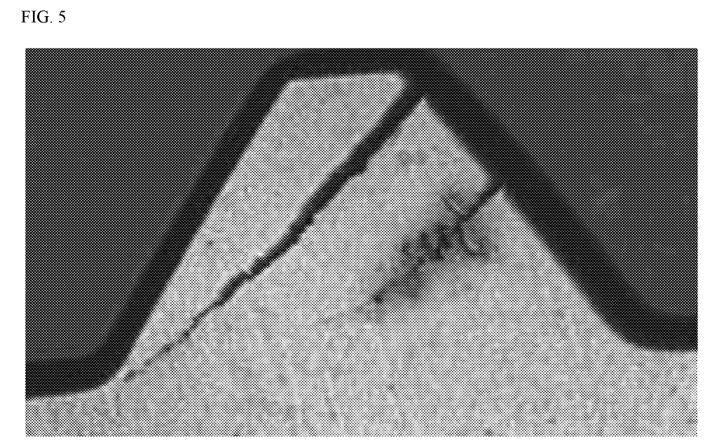

If the surface hardness of the outer circumferential surface splines 630 of the coupler 600 is formed to be excessively low, there may be a concern that sufficient strength required for stable transmission of driving power cannot be secured. On the other hand, if the surface hardness of the outer circumferential surface splines 630 of the coupler 600 is formed to be excessively high, brittleness may become excessively high, thereby increasing a risk that cracks occur in tooth portions as shown in FIG. 5, and further increasing a cycle time for machining or a risk of occurrence of defective products due to the high hardness. Accordingly, it may be preferable that the surface hardness of the outer circumferential surface splines 630 of the coupler 600 is controlled within the above-described range.

According to an embodiment of the present disclosure, a recess 640 recessed radially inward may be provided on an outer circumferential surface of a coupler 600, and a stopper member 700 may be inserted into and mounted to the recess 640.

According to an embodiment of the present disclosure, the stopper member 700 may perform a function of limiting axial movement of a clutch member (not shown) that is engaged with outer circumferential surface splines 630 of the coupler 600.

That is, the stopper member 700 may perform as a stopper for preventing the clutch member (not shown), which is engaged with the outer circumferential surface splines 630 of the coupler 600, from excessively moving axially outward.

According to an embodiment of the present disclosure, the stopper member 700 may be formed as a ring-shaped member (for example, a snap ring) having a circular cross-sectional shape.

According to an embodiment of the present disclosure, the stopper member 700 may be formed as a substantially C-shaped ring member (for example, a snap ring) having a portion cut away in a circumferential direction.

According to an embodiment of the present disclosure, the recess 640 provided on the outer circumferential surface of the coupler 600 and the stopper member 700 mounted therein may be positioned axially inward relative to an axial center of the coupler 600 so as to ensure stable engagement with the clutch member (not shown).

In the vehicular wheel bearing 100 according to an embodiment of the present disclosure, when switching to a four-wheel drive mode, a clutch member (not shown) moves axially outward to a position at which the clutch member comes into contact with the stopper member 700. If the stopper member 700 is positioned excessively axially outward, the clutch member may move excessively axially outward, thereby shortening an engagement length between the clutch member and a constant-velocity joint, which may cause a problem in that stable transmission of driving power cannot be achieved. [For stable transmission of driving power in the four-wheel drive mode, it may be preferable that an engagement length between the clutch member and a coupler 600 and an engagement length between the clutch member and the constant-velocity joint are formed to be similar.]

In order to address the above-described problem, a method of forming the clutch member with an increased axial length may be considered; however, a clutch member having a long length may increase the weight of the component and reduce productivity, and may also cause a problem in that operability is degraded due to an increase in a distance over which the clutch member must move for engagement with and disengagement from the coupler 600.

According to an embodiment of the present disclosure, in order to secure a stable engagement length for transmission of driving power, an axial length of outer circumferential surface splines 630 positioned axially inward relative to the stopper member 700 may preferably be configured to be 5 mm or greater.

According to an embodiment of the present disclosure, the outer circumferential surface splines 630 positioned axially inward relative to the stopper member 700 may be configured to have an axial length in a range of 30% to 50% of an axial length of the clutch member (not shown).

According to an embodiment of the present disclosure, the outer circumferential surface splines 630 positioned axially inward relative to the stopper member 700 may be configured to have an axial length in a range of 30% to 50% of an axial length of the coupler 600.

If outer circumferential surface splines 630 positioned axially inward relative to the stopper member 700, that is, outer circumferential surface splines 630 engaged with a clutch member (not shown), are formed to have an axial length of less than 30% of an axial length of the clutch member (not shown) and/or the coupler 600, a sufficient spline engagement length between the clutch member and the coupler 600 cannot be secured, making it difficult to ensure stable transmission of driving power. In addition, due to the limited spline engagement length, stress may be concentrated on a partial region of the splines, thereby increasing a risk that damage such as cracks occurs.

Conversely, if the outer circumferential surface splines 630 positioned axially inward relative to the stopper member 700, that is, the outer circumferential surface splines 630 engaged with the clutch member (not shown), are formed to have an axial length exceeding 50% of the axial length of the clutch member (not shown) and/or the coupler 600, the axial length of the clutch member must be increased correspondingly, which may cause an increase in weight of a wheel bearing assembly and an increase in an axial length thereof.

Accordingly, it may be preferable that the axial length of the outer circumferential surface splines 630 positioned axially inward relative to the stopper member 700 is controlled to be within the above-described range.

Meanwhile, in the embodiment shown in the drawings, for convenience of manufacturing, the outer circumferential surface splines 630 of the coupler 600 are configured to be formed on an entire outer circumferential surface of the coupler 600; however, the outer circumferential surface splines 630 of the coupler 600 may alternatively be configured to be formed only on a portion of the outer circumferential surface of the coupler 600.

For example, the outer circumferential surface splines 630 of the coupler 600 may be configured to be formed only at an axially inward portion at which the clutch member is engaged [in the embodiment shown in the drawings, at a portion positioned axially inward relative to the stopper member 700].

In addition, in the embodiment shown in the drawings, for convenience of manufacturing, a hardening heat treatment is configured to be performed over the entire outer circumferential surface splines 630 formed on the entire outer circumferential surface of the coupler 600 [for example, on both outer circumferential surface splines positioned axially inward relative to the stopper member 700 and outer circumferential surface splines positioned axially outward relative to the stopper member 700]; however, the hardening heat treatment may alternatively be configured to be performed only on the portion of the outer circumferential surface splines positioned axially inward relative to the stopper member 700 (that is, the portion engaged with the clutch member).

Although the present disclosure has been described above with reference to specific matters such as particular constituent elements and limited embodiments, these embodiments are provided only to assist in a more comprehensive understanding of the present disclosure, and the present disclosure is not limited thereto. Rather, various modifications and variations may be made from such descriptions by a person having ordinary skill in the art to which the present disclosure pertains.

Accordingly, the spirit of the present disclosure should not be construed as being limited to the embodiments described above, and not only the claims set forth below but also all modifications and variations that are equivalent or substantially equivalent to the scope of the claims should be understood as falling within the scope of the spirit of the present disclosure.

### EXPLANATION OF REFERENCE NUMERALS

100: vehicular wheel bearing

200: wheel hub

210: wheel-mounting flange

220: forming portion

230: inner-ring mounting portion

240: coupler mounting portion

300: inner ring

400: outer ring

410: vehicle-body-side mounting flange

500: rolling element

600: coupler

610: inner circumferential surface splines

620: protrusion

630: outer circumferential surface splines

640: recess

700: stopper member

What is claimed is:

1. A wheel bearing (100) for a part-time four-wheel drive vehicle capable of switching between a two-wheel drive mode and a four-wheel drive mode, comprising:
a wheel hub (200) to which a vehicle wheel is mounted and which rotates together with the vehicle wheel;
at least one inner ring (300) mounted to the wheel hub (200);
an outer ring (400) fixedly coupled to a vehicle-body-side member;
a plurality of rolling elements (500) configured to rotatably support the wheel hub (200) and the inner ring (300) relative to the outer ring (400); and
a coupler (600) mounted to the wheel hub (200),
wherein the coupler (600) comprises outer circumferential surface splines (630) extending in an axial direction on an outer circumferential surface thereof, and
wherein the outer circumferential surface splines (630) of the coupler (600) are configured such that a hardening heat treatment is performed at least on a portion that is engaged with a clutch member.

2. The wheel bearing according to claim 1, wherein the outer circumferential surface splines (630) of the coupler (600) subjected to the hardening heat treatment is configured such that a surface hardness measured at a pitch circle diameter portion is in a range of 600 HV to 660 HV.

3. The wheel bearing according to claim 2, wherein the outer circumferential surface splines (630) of the coupler (600) subjected to the hardening heat treatment is configured such that a surface hardness measured at a pitch circle diameter portion is in a range of 620 HV to 640 HV.

4. The wheel bearing according to claim 3, wherein the coupler (600) comprises a recess (640) recessed radially inward on an outer circumferential surface thereof.

5. The wheel bearing according to claim 4, wherein a stopper member (700) configured to limit axial movement of the clutch member is inserted into and coupled to the recess (640) of the coupler (600).

6. The wheel bearing according to claim 5, wherein the stopper member (700) is formed as a snap ring having elasticity.

7. The wheel bearing according to claim 6, wherein the stopper member (700) is formed as a C-shaped snap ring having a portion cut away in a circumferential direction.

8. The wheel bearing according to claim 5, wherein the recess (640) of the coupler (600) and the stopper member (700) are configured to be positioned axially inward relative to an axial center of the coupler (600).

9. The wheel bearing according to claim 5, wherein outer circumferential surface splines (630) of the coupler (600) that are positioned axially inward relative to the stopper member (700) is formed to have an axial length that is in a range of 30% to 50% of an axial length of the clutch member.

10. The wheel bearing according to claim 5, wherein outer circumferential surface splines (630) of the coupler (600) that are positioned axially inward relative to the stopper member (700) is formed to have an axial length that is in a range of 30% to 50% of an axial length of the coupler (600).

11. The wheel bearing according to claim 1, the inner ring (300) and the coupler (600) are configured to be fixed on the wheel hub (200) by a forming portion (220) formed by plastically deforming an inner axial end portion of the wheel hub (200) radially outward.

12. The wheel bearing according to claim 1, wherein the coupler (600) comprises inner circumferential surface splines (610) extending in an axial direction on an inner circumferential surface thereof, such that the inner circumferential surface splines (610) are spline-coupled to the wheel hub (200).

13. The wheel bearing according to claim 12, wherein the coupler (600) comprises a protrusion (620) protruding radially inward from an inner circumferential surface portion that is positioned axially inward relative to the inner circumferential surface splines (610).

14. The wheel bearing according to claim 13, wherein the wheel hub (200) comprises an inner-ring mounting portion (230) and a coupler mounting portion (240) on an outer circumferential surface thereof,
wherein the inner-ring mounting portion (230) comprises a cylindrical press-fit portion such that the inner ring (300) is press-fitted to the cylindrical press-fit portion, and
wherein the coupler mounting portion (240) comprises a spline coupling portion extending in an axial direction such that the inner circumferential surface splines (610) of the coupler (600) are spline-coupled to the spline coupling portion of the coupler mounting portion (240).

15. The wheel bearing according to claim 14, an outer diameter of the spline coupling portion provided on the coupler mounting portion (240) is formed to be smaller than an outer diameter of the cylindrical press-fit portion of the inner-ring mounting portion (230).
